(19) United States
(12) Patent Application Publication
(10) Pub. No.: US 2006/0157200 A1
(43) Pub. Date: Jul. 20, 2006

(54) Method and apparatus for forming surface shape, method and apparatus for forming flying surface shape of magnetic head

(75) Inventors: Yoshiaki Ito, Shatin (HK); Takeshi Nakada, Shatin (HK); Kunihiro Ueda, Shatin (HK)

Correspondence Address: GREENBLUM & BERNSTEIN, P.L.C., 1950 ROLAND CLARKE PLACE, RESTON, VA, 20191, US

(73) Assignee: SAE Magnetics (H.K.) Ltd., of Hong Kong, Hong Kong (HK)

(21) Appl. No.: 11/326,480

(22) Filed: Jan. 6, 2006

(30) Foreign Application Priority Data
Jan. 18, 2005 (JP) 2005-9942

(51) Int. Cl. B44C 1/22; C23F 1/00

(52) U.S. Cl. 156/345.31; 216/22

(57) ABSTRACT

To form a surface shape of an etching object in a short time at low cost, and to make the surface shape to be formed highly accurate. An apparatus for forming a surface shape includes a resist forming device for forming a resist of a predetermined shape on a predetermined surface of the etching object, and an etching device for performing etching to the predetermined surface of the etching object on which the resist is formed. The resist forming device includes a resist discharging device for forming a resist of a predetermined shape by discharging a resist material to the predetermined surface of the etching object.

### BACKGROUND OF THE INVENTION

1. Field of the Invention

The present invention relates to a method and an apparatus for forming a surface shape, and in particular, to a method and an apparatus for forming a surface shape by forming a resist and performing etching.

2. Related Art

A magnetic disk drive (HDD) is provided with a magnetic head in which a magnetic head element part for reading and writing data with respect to a magnetic disk is formed. In a recent magnetic disk drive, as data to be recorded becomes denser, there are increasing demands for lowering the flying height in order to make the magnetic head close to the magnetic disk surface as much as possible.

In order to realize such a low flying height, on the air bearing surface of a magnetic head, an irregular pattern of a predetermined shape is formed so as to generate an appropriate dynamic pressure with an air flow flown in when the magnetic disk is rotated. The shape of the air bearing surface becomes more complex in recent years, so in the forming method thereof, it is indispensable to perform etching in multiple stages (multiple cycles).

For example, Patent Document 1 (publication of Japanese Patent Application Laid-open No. 10-228617) discloses a typical method of forming an air bearing surface of a magnetic head. The method will be explained with reference to FIG. 10. First, to a bar-shaped wafer on which a plurality of magnetic head structural bodies are aligned in a line, predetermined lapping processing is performed, and then a resist of a predetermined pattern is applied (step S101). Next, cure processing is performed (step S102), and exposure (step S103) and development are performed (step S104). Then, dry etching is performed (step S105). Through the five steps described above, one level difference is formed. In order to form more level differences, after the applied resist is removed (negative determinations in step S106 and step S107), steps S101 to S105 are repeated. Thereby, it is possible to form an air bearing surface with complex irregularities having multiple level differences.

However, in the method of forming an air bearing surface of a magnetic head in the conventional example described above, an applied resist is exposed and developed, so it is difficult to form an extremely complex shape. This causes a problem that it is difficult to cope with forming an air bearing surface of a magnetic head which becomes or will become more complex in recent years or in the future.

Further, when forming each level difference, exposure and development are performed to each applied resist each time, so the number of steps for forming an air bearing surface tends to increase further. This causes a problem that the manufacturing time and the manufacturing cost of a magnetic head increase. Along with it, exposure and development are required for forming a resist each time, whereby the alignment thereof is troublesome. This causes a problem that the accuracy in the shape of the air bearing surface to be formed is degraded, and the manufacturing time further increases.

Moreover, a large number of reticles (masks) of a predetermined pattern must be prepared, which may lead to a problem of an increase in the manufacturing cost. Further, in exposure, if the resist is thicker comparing with the focus depth of the imaging surface, the end face of the resist after development cannot be formed sharply, whereby the wall angle of the irregularities defined by etching cannot be formed steeply. Accordingly, there is also caused a problem that it is difficult to stabilize the flying height in such a magnetic head slider.

### SUMMARY OF THE INVENTION

It is therefore an object of the present invention to form a surface shape of an etching object in a short time at low cost, and to make the surface shape to be formed highly accurate.

In view of the above, a method of forming a surface shape, which is an embodiment of the present invention, comprises: a resist forming step in which a resist of a predetermined shape is formed on a predetermined surface of an etching object; and an etching step in which etching is performed to the predetermined surface of the etching object on which the resist is formed. In the resist forming step, the resist of the predetermined shape is formed by discharging a resist material to the predetermined surface of the etching object.

In the resist forming step, the resist material is discharged by an inkjet system or a bubble jet system. At this time, the resist forming step is characterized in that the resist material is discharged in a discharge amount of not more than 2 pl (picoliter) Further, the resist forming step is characterized in that the resist material is discharged in a discharge amount of not more than 0.5 pl (picoliter).

Further, the method comprises a resist removing step in which, after the etching step, all of the resist formed is removed, and after the resist removing step, the resist forming step and the etching step are performed repeatedly.

According to the invention described above, first, fine droplets of a resist material (desirably, not more than 2 pl, and more desirably, not more than 0.5 pl) are discharged by an inkjet system or a bubble jet system to a predetermined surface of an etching object, whereby a resist is plotted in a predetermined shape. Then, through etching, a dented part is formed in the part not covered with the resist, whereby irregularities are formed on the predetermined surface of the etching object. Thereby, a conventional step in which exposure and development are performed to a resist applied to the predetermined surface when forming the resist is not required any more, so it is possible to form a resist directly with high accuracy.

Accordingly, the steps of forming a surface shape can be shortened, and by repeating the steps described above, complex irregularities can be formed with high accuracy. Further, since exposure and development are not required, reticles are not needed, which leads to a cost reduction. Further, although highly accurate positioning is required for exposure and development when etching is performed repeatedly, such processing is not required, so it is possible to reduce the processing time in the forming steps.

In particular, by using the aforementioned method of forming an air bearing surface of a magnetic head, it is possible to form an air bearing surface having fine and complex irregularities with high accuracy. At this time, since the resist can be formed to be thin, the end face of the resist can be formed sharply, so the wall angle of the irregularities defined by etching can be made steeper. Thereby, it is possible to stabilize the flying height of the magnetic head, and to improve the reliability of reading and writing of data performed by using the magnetic head.

Further, the method comprises: after the etching step, a laser irradiating step in which a laser beam is irradiated to the resist material formed on the etching object in another resist forming step which has been performed so as to remove a part of the resist material, and performing a new resist formation of a predetermined shape; and after the laser irradiating step, the etching step. At this time, the laser irradiating step is characterized in that the resist material is thermally decomposed and removed by the laser beam. For example, the resist material is sublimated and removed by the laser beam.

According to the configuration described above, a laser beam is irradiated to an unnecessary part of the resist formed by discharging on the predetermined surface of the etching object so as to heat it, and the unnecessary resist is removed by an action such as a thermal decomposition. Thereby, a resist of a predetermined shape is formed. Then, etching is performed and a surface shape is formed. Thereby, since a resist of a predetermined shape is formed with a laser beam capable of positioning with high accuracy, a surface shape can be formed with higher accuracy. In particular, a part of the resist, which has been used for etching once, having been formed on the predetermined surface of the etching object is removed and a new resist shape is formed, the resist can be used effectively, whereby it is possible to reduce the cost of forming the surface shape and to reduce the processing time.

Further, an apparatus for forming a surface shape, which is another mode of the present invention, comprises: a resist forming device for forming a resist of a predetermined shape on a predetermined surface of an etching object; and an etching device for performing etching to the predetermined surface of the etching object on which the resist is formed. The resist forming device includes a resist discharging device for forming the resist of the predetermined shape by discharging a resist material on the predetermined surface of the etching object.

At this time, the resist discharging device discharges the resist material by an inkjet system or a bubble jet system. Further, the apparatus comprises a resist removing device for removing all of the resist formed on the predetermined surface of the etching object.

Further, the apparatus comprises a laser irradiating device for irradiating a laser beam to the resist material formed on the etching object so as to remove a part of the resist material, and forming a resist of a predetermined shape.

Further, the apparatus comprises a control device for controlling the operation of the resist discharging device and the laser irradiating device. The control device stores resist shape data indicating a shape of a resist to be formed on the predetermined surface of the etching object, and based on the resist shape data stored, controls the operation of the resist discharging device and the laser irradiating device so as to form the resist.

Further, the apparatus comprises a movable table, on which the etching object is mounted, moving along the mounting surface so as to set a position of the etching object when forming the resist by the resist discharging device and the laser irradiating device. At this time, the resist discharging device or the laser irradiating device moves corresponding to the moving operation of the movable table, and discharges the resist material or irradiates a laser beam.

In the present invention, an etching object which is the object of forming a predetermined surface is a magnetic head. The present invention also provides an apparatus for forming an air bearing surface of a magnetic head in which an air bearing surface of the magnetic head is formed by using the apparatus for forming a surface shape described above.

Since either of the apparatus for forming a surface shape or an apparatus for forming an air bearing surface of a magnetic head having the above-described configurations acts in a manner similar to that of the above-described method of forming a surface shape, the object of the present invention can be achieved. As described above, when a movable table is provided, a resist discharging operation or a laser irradiating operation can be performed effectively, so it is possible to realize resist forming processing rapidly with high accuracy.

Further, the present invention provides a magnetic head in which the corner of a protruded part in a predetermined shape formed on the air bearing surface facing the magnetic disk has a predetermined radius. In particular, the radius of the corner of the protruded part is preferably 2 to 5 nm (nanometer). The corner of the protruded part is formed by using a method of forming a surface shape having a step of discharging and attaching a resist as described above. In this way, by providing a fine radius in the corner of the protruded part on the air bearing surface, that is, by rounding the corner, the flying characteristics of the magnetic head can be improved. Further, such a fine radius is automatically formed by using a resist discharged and attached by using inkjet or the like. Therefore, it is possible to form the shape of the air bearing surface rapidly with high accuracy as described above, and to form a magnetic head having excellent flying characteristics.

### EFFECT OF THE INVENTION

The present invention is configured and works as described above. Therefore, exposure and development processing shown in the conventional example is not required, whereby it is possible to simplify the steps of forming a surface shape, to reduce the processing time, and to reduce the manufacturing cost. Further, since a resist is formed with high accuracy, the present invention has such an excellent effect that even a complex surface shape can be formed with high accuracy, which has not been enjoyed conventionally.

### BRIEF DESCRIPTION OF THE DRAWINGS

FIG. 1 is a block diagram showing the configuration of an apparatus for forming an air bearing surface in an embodiment 1;

FIG. 2 is a functional block diagram showing the configuration of a controller in the embodiment 1;

FIGS. 3A to 3D are diagrams showing states of forming the air bearing surface in the embodiment 1, respectively;

FIGS. 4A to 4D are diagrams showing states of forming the air bearing surface in the embodiment 1, respectively, continued from FIG. 3D;

FIG. 5 is a flowchart showing the operation in the embodiment 1;

FIG. 6 is a block diagram showing the configuration of an apparatus for forming an air bearing surface in an embodiment 2;

FIGS. 7A to 7D are diagrams showing states of forming the air bearing surface in the embodiment 2, respectively;

FIGS. 8A to 8D are diagrams showing states of forming the air bearing surface in the embodiment 2, respectively, continued from FIG. 7D;

FIG. 9 is a flowchart showing the operation in the embodiment 2;

FIGS. 10A and 10B are diagrams showing a state of etching in an embodiment 3; and

FIG. 11 is a flowchart showing the operation of forming an air bearing surface in a conventional example.

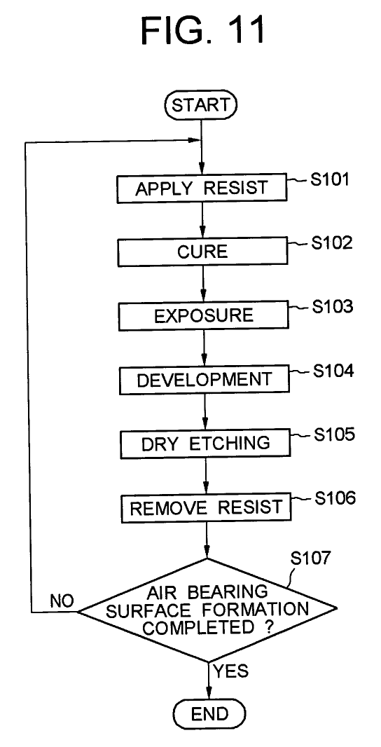

### DESCRIPTION OF PREFERRED EMBODIMENTS

The present invention is characterized in an aspect that when forming a resist on an etching object to which etching is performed, a resist material is directly discharged to the etching object so as to plot a resist of a predetermined shape. Further, the present invention is also characterized in an aspect that a resist of a predetermined shape is plotted by irradiating a laser beam to a part of a resist which has been applied so as to remove the part.

Hereinafter, a magnetic head for reading data from a magnetic disk in a hard disk drive (HDD) will be used particularly as an example of an etching object on which a surface shape is formed, and an explanation will be given for a case where a resist is formed in order to perform etching to the air bearing surface (ABS) thereof. Note that a surface formed by using the present invention is not limited to an air bearing surface of a magnetic head, and an etching object serving as the object of forming a surface shape is not limited to a magnetic head.

### Embodiment 1

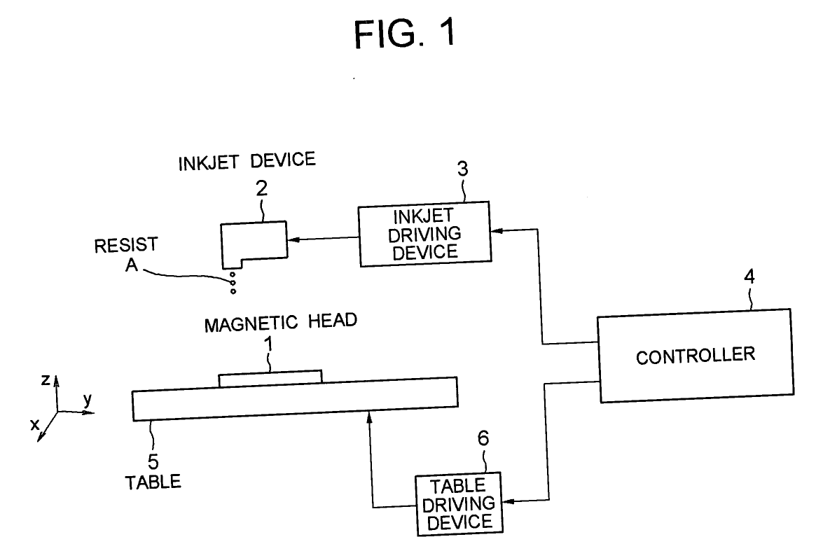

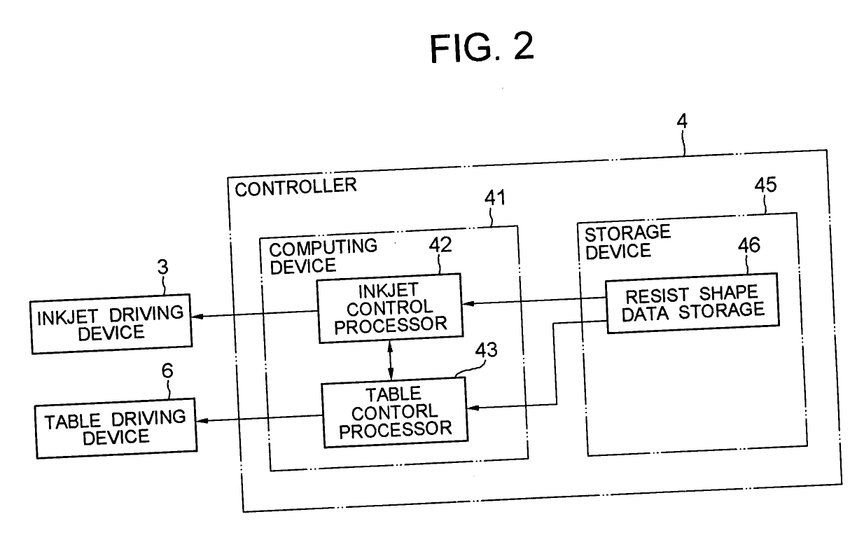

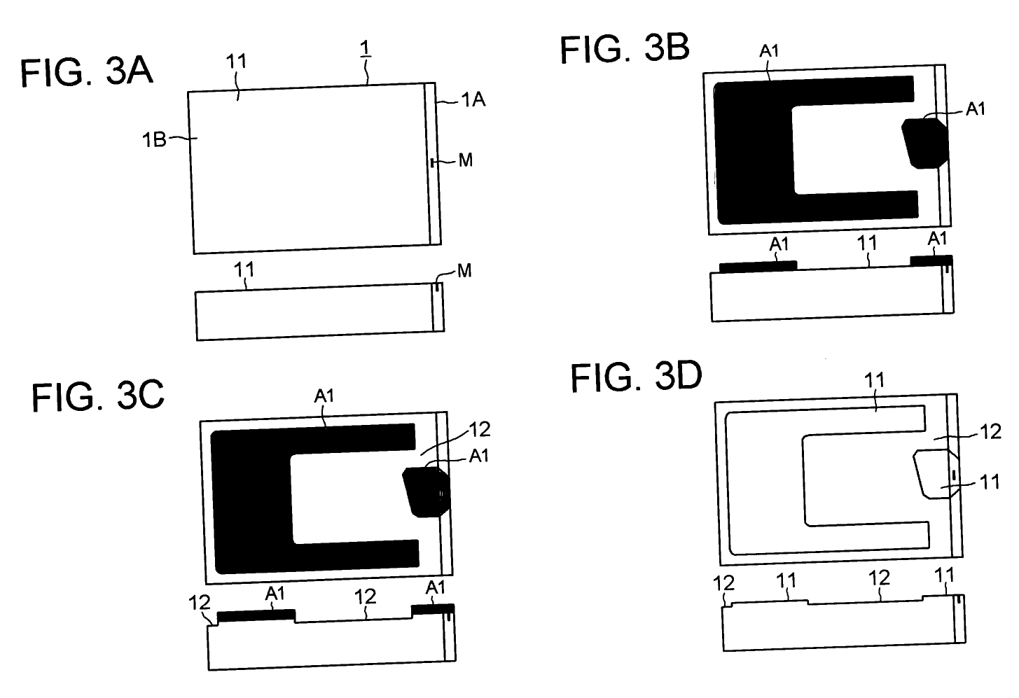

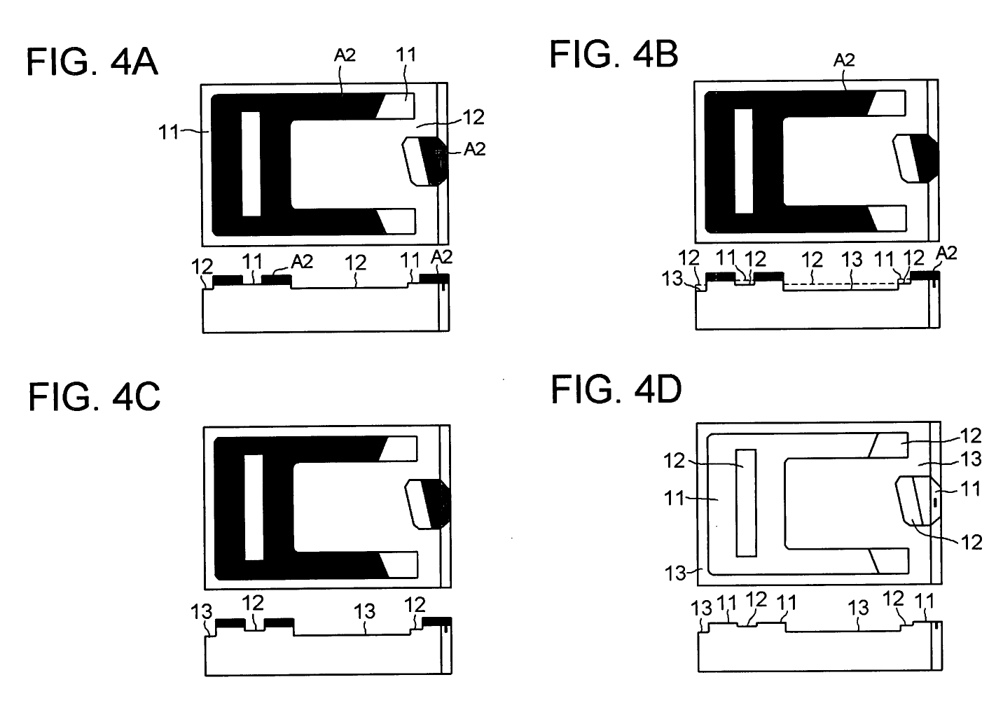

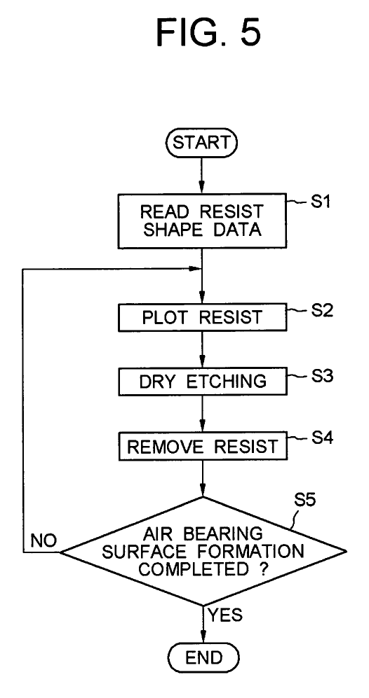

A first embodiment of the present invention will be explained with reference to FIGS. 1 to 5. FIG. 1 is a block diagram showing the configuration of an apparatus for forming an air bearing surface of a magnetic head. FIG. 2 is a functional block diagram showing the configuration of a controller. FIGS. 3A to 4D are explanatory diagrams showing states of forming an air bearing surface of a magnetic head. FIG. 5 is a flowchart showing the operation of the apparatus for forming a surface shape.

[Configuration]

As shown in FIG. 1, an apparatus for forming an air bearing surface of a magnetic head (surface shape forming apparatus), which is the present invention, includes: an inkjet device 2 (resist discharging device (resist forming device)) for discharging a resist material A so as to form a resist of a predetermined shape with respect to a magnetic head 1; an inkjet driving device 3 for driving the inkjet device 2 so as to perform positioning; and an etching device (not shown) for performing etching to the magnetic head 1 on which a resist is formed. Further, the apparatus includes: a table 5 (movable table), on which the magnetic head 1 is mounted, moving along the mounting surface so as to set the position of the magnetic head 1; a table driving device 6 for driving the table 5; and a controller 4 (control device) for controlling resist discharge operation of the inkjet device 2. Further, although not shown, a resist removing device for removing all of the resist which has been formed on the magnetic head 1 but is not required any more. Hereinafter, each configuration will be explained in detail.

<Magnetic Head>

The magnetic head 1 is an etching object which is formed in a magnetic head capable of being mounted in a disk drive later. As shown in FIG. 3A, the magnetic head 1 is formed in a rectangle shape with a predetermined thickness, and there is formed a magnetic head element part 1A including a magneto-resistance effect element M for reading data on one end thereof. The other end side thereof is called a magnetic head slider part 1B (main body). On one surface of the magnetic head 1 where the magneto-resistance effect element M is exposed, an air bearing surface (ABS) having irregularities (level differences) of a predetermined shape for realizing a low flying operation with respect to the magnetic disk is formed in such a manner that etching is performed after resist formation and the processing is repeated, as described later. Accordingly, the magnetic head 1 is mounted on the table 5 such that a surface where the magneto-resistance effect element M is exposed (surface denoted by the reference numeral 11) faces upward, and respective steps described later will be performed.

<Table>

The table 5 is for fixedly mounting the magnetic head 1 thereon. The table 5 is supported by the table driving device 6 and moves along the mounting surface (on the X-Y plane). Accordingly, the table is capable of moving the position on the X-Y plane of the magnetic head 1 with respect to the inkjet device 2.

The table driving device 6 drives the position of the table 5, controlled by the controller 4 described later when a resist is formed on the magnetic head 1 mounted. At this time, since it moves corresponding to the discharge of the resist material A from the inkjet device 2, it is movable corresponding to the shape of the resist to be formed. For example, it is movable at a speed of not less than 10 mm/sec, and it is desirable to have a positioning accuracy of more than 2 μm.

<Inkjet Device>

The inkjet device 2 is a device for discharging the resist material A by an inkjet system. The inkjet device 2 is supported by the inkjet driving device 3, and discharges the resist material A corresponding to a control instruction from the controller 4. At this time, since it is controlled based on resist shape data which has been defined in the controller 4 as described later, the inkjet device 2 is controlled to move to a position where a resist is plotted to be in such a shape, and discharge of the resist material A is controlled.

Further, corresponding to the operation of the inkjet device 2, the operation of the table 5 is also controlled by the controller 4 as described above. That is, with the inkjet device 2 and the table 5 being operated in cooperation, it is possible to rapidly move the inkjet device 2 to the position based on the resist shape data with respect to the resist forming location of the magnetic head 1, whereby resist plotting can be performed rapidly with high accuracy.

The inkjet device 2 is movable at a speed of not less than 0.1 mm/sec, and it is desirable to have a positioning accuracy of more than 2 μm. Further, it is desirable that a discharge cycle of the resist material A be not less than 10 kHz, and that the discharge amount of one time (one drop) be not more than 2 pl (picoliter). More desirably, the discharge amount should be not more than 0.5 pl (picoliter). In the present embodiment, the resist material A to be discharged is preferably prepared by using a material having resistance to dry etching performed by an etching device described later and capable of being discharged in fine droplets as described above. For example, styrene resin having EL (ethyl lactate) of small molecular weight as a solvent is desirable. Alternatively, styrene resin having PGMEA (propylene glycol monomethyl ethyl acetate) as a solvent is also usable. However, the resist material is not limited to those described above.

In this way, by plotting a resist by discharging the resist material A by the inkjet device 2, the thickness of the resist can be 3 to 6 μm, which is much thinner comparing with the conventional case of forming a resist by performing exposure and development where the thickness is 10 to 20 μm. Thereby, it is possible to form the wall of the dented part steeply through etching.

Although, in the present embodiment, a case in which the resist material A is discharged to the magnetic head 1 by the inkjet device 2 is exemplary described, a discharging method is not limited to this. Instead of the inkjet device 2, a device for discharging the resist material A by a bubble jet system may be used for forming a resist. Further, the present invention is not limited to the method described above, and a device capable of plotting a resist by discharging the resist material A in another structure may be used.

<Controller>

The controller 4 includes a computing device 41 such as a CPU, and a storage device 45 such as a ROM which is rewritable and capable of saving stored data. In the storage device 45, there is formed a resist shape data memory 46 for storing resist shape data to be plotted on the magnetic head 1 by the inkjet device 2. The resist shape data is registered by an operator beforehand, including data of a different shape for each stage (each cycle) of etching performed to the air bearing surface of the magnetic head 1. For example, in order to form an air bearing surface of the shapes shown in FIGS. 3A to 4D, shapes (shaded shapes) shown in FIGS. 3B and 4A are plotted respectively before etching as described later, so such two patterns of resist shape data are stored.

In the computing device 41, with a predetermined program being incorporated beforehand, an inkjet control processor 42 for controlling the operation of the inkjet device 2 and a table control processor 43 for controlling the operation of the table 5 are constructed. The inkjet control processor 42 reads out resist shape data to be formed in the current step from the resist shape data memory 46, and transmits an instruction to the inkjet driving device 3 so as to form a resist of such a shape on the air bearing surface of the magnetic head 1 mounted on the table 5. Thereby, the inkjet device 2 discharges the resist material A while moving in X, Y and Z directions so as to plot a resist of the instructed shape. Further, the table control processor 43 works in cooperation with the inkjet control processor 42 to move the position of the mounted magnetic head 1 on the X-Y plane so as to enable plotting of the predetermined resist shape by the inkjet device 2. Thereby, movement of the inkjet device 2 can be suppressed to the minimum, and the plotting processing can be performed rapidly, and exhaustion of the inkjet device 2 can be suppressed.

<Other Configurations>

Next, an etching device, not shown, will be explained. As described above, the etching device is a device for performing etching, with respect to the magnetic head 1 on which the resist has been plotted by the inkjet device 2, to a part where the resist has not been plotted. For example, the etching device irradiates an ion beam to the magnetic head 1 so as to perform dry etching such as ion beam etching. Note that the etching device may perform etching by any other method.

Further, a resist removing device, also not shown, is formed in the magnetic head 1 as described above, and removes all parts of the resist not required any more. For example, resist is removed after etching of each stage (each cycle) is completed but before forming a resist of the next step.

[Operation]

Next, the operation of a method of forming an air bearing surface (method of forming a surface shape) by using the above-described apparatus for forming an air bearing surface of a magnetic head will be explained with reference to FIGS. 3A to 5. FIGS. 3A to 4D show states of an air bearing surface by respective steps for forming an air bearing surface shape having irregularities on the air bearing surface of the magnetic head 1. In each Figure, a plan view of the air bearing surface of the magnetic head 1 in each stage is shown in the upper part, and a central sectional view thereof is shown in the lower part. Further, FIG. 5 is a flowchart showing the operation of the apparatus of an air bearing surface of a magnetic head at that time.

First, the inkjet control processor 42 and the table control processor 43 of the controller 4 read out resist shape data from the resist shape data memory 46 (step S1), and based on the data, drive the inkjet device 2 and the table 5 so as to discharge the resist material A from the inkjet device 2 to thereby plot a resist in a predetermined shape (step S2, resist forming step). For example, in the first cycle, on the flat air bearing surface (denoted by the reference numeral 11) of the magnetic head 1 shown in FIG. 3A, a resist A1 of a shape shown by the shaded part in FIG. 3B is formed.

Next, to the air bearing surface of the magnetic head 1 on which the resist A1 is formed, dry etching is performed by an etching device (not shown) (step S3, etching step). With this step, as shown in FIG. 3C, a part on which the resist A1 has not been formed is eroded by a predetermined height, so a dented part of a predetermined depth denoted by the reference numeral 12 is formed. Then, the resist A1 formed on the magnetic head 1 is removed by a resist removing device (not shown) (step S4, resist removing process). Thereby, in the magnetic head 1, the air bearing surface is in a state where the part denoted by the reference numeral 11 is the highest and a low level (dent) denoted by the reference numeral 12 is formed (see FIG. 3D), and the first cycle ends.

Then, when forming a further level difference (irregularity) (negative determination in step S5), a resist forming step and an etching step of the second cycle are performed. More specifically, based on the resist shape of the second cycle included in the resist shape data read out from the resist shape data memory 46, the inkjet device 2 and the table 5 are moved in the similar manner as described above so as to discharge the resist material A from the inkjet device 2 to thereby plot a resist in a predetermined shape (step S2, resist forming process). In the present embodiment, a resist A2 of the shape shown by the shaded part in FIG. 4A is formed in the second cycle.

Next, to the air bearing surface of the magnetic head 1 on which the resist A2 is formed, dry etching is performed by an etching device (not shown) (step S3, etching step). With this step, as shown in FIGS. 4B and 4C, the part where the resist A2 is not formed is eroded by a predetermined height. Note that a shape indicated by the dotted line in FIG. 4B shows the position of the air bearing surface before etching. Thereby, on the plane of the height denoted by the reference numeral 11 before etching, a lower level denoted by the reference numeral 12 is formed, and on the plane of the height denoted by the reference numeral 12 before etching, a further lower level denoted by the reference numeral 13 is formed. Note that the height denoted by the reference numeral 12 formed in the second cycle and the height denoted by the reference numeral 12 formed in the first cycle are not necessarily the same height. For example, they may differ depending on the etching time in each cycle or the like.

Then, the resist A1 formed on the magnetic head 1 is removed by the resist removing device (not shown) (step S4, resist removing step), and formation of the air bearing surface is completed (positive determination in step S5).

Thereby, as shown in FIG. 4D, the air bearing surface of the magnetic head 1 is formed such that the part denoted by the reference numeral 11 is the highest, the part denoted by the reference numeral 12 is in a lower level (dented part), and the part denoted by the reference numeral 13 is in the lowest level (dented part), whereby an air bearing surface having two level differences is formed.

As described above, since fine droplets of the resist material A are discharged from the inkjet device 2 so as to plot a resist in a predetermined shape, resist formation can be performed with high accuracy, and the accuracy of the air bearing surface formed by etching thereafter can be improved, whereby, it is possible to form an air bearing surface having more complex irregularities. Accordingly, exposure and development processing, performed to a resist in each cycle conventionally, is not required, so the steps of forming can be shortened. This means reticles required in exposure and development steps are not needed, and also positioning operation of high accuracy is not needed. This enables to shorten the steps of forming further, and to reduce the manufacturing cost.

Further, the end face of a resist plotted can be formed sharply since the resist is formed to be thin, whereby it is possible to form the wall angle of the irregularities steeply. Thereby, it is possible to stabilize the flying height of a magnetic head, and to improve the reliability in reading and writing of data performed by using the magnetic head.

Although a case in which two level differences are formed by etching in two stages (two cycles) has been exemplary described, a more complex shape of an air bearing surface may be formed by repeating the resist forming step, the etching step and the resist removing step.

### Embodiment 2

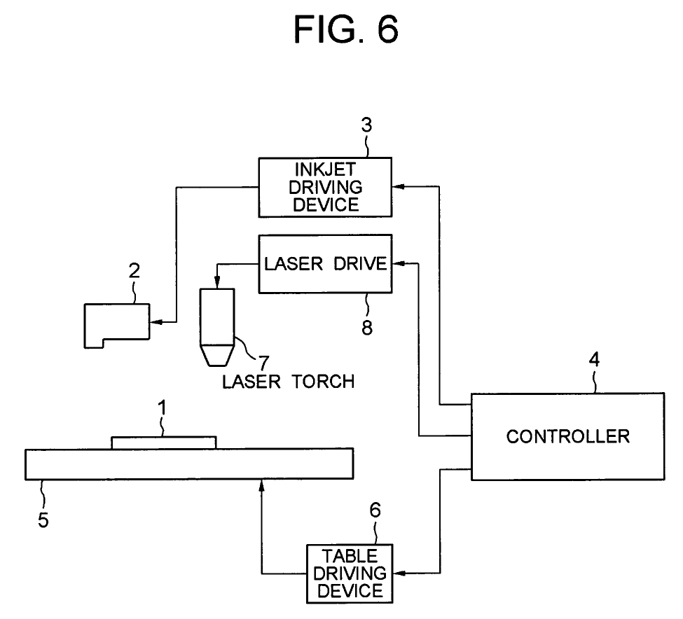

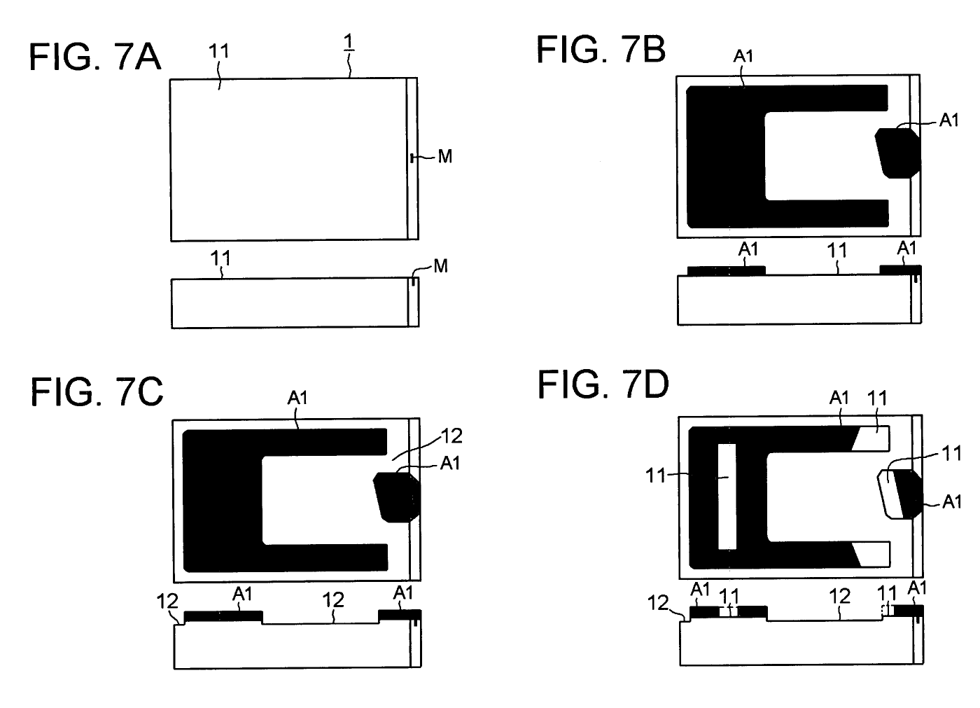

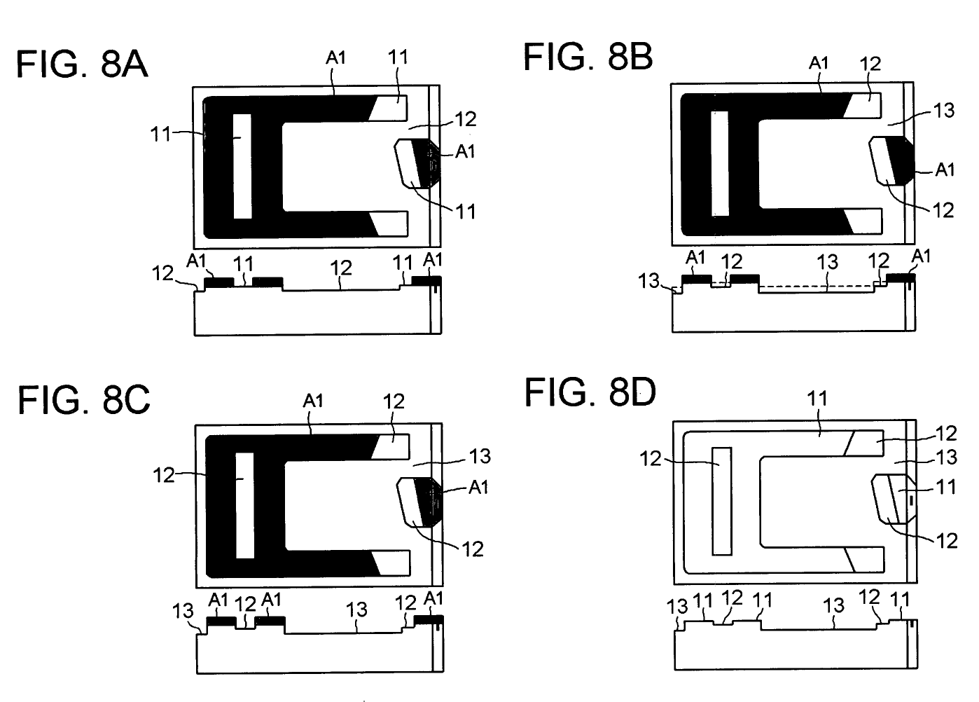

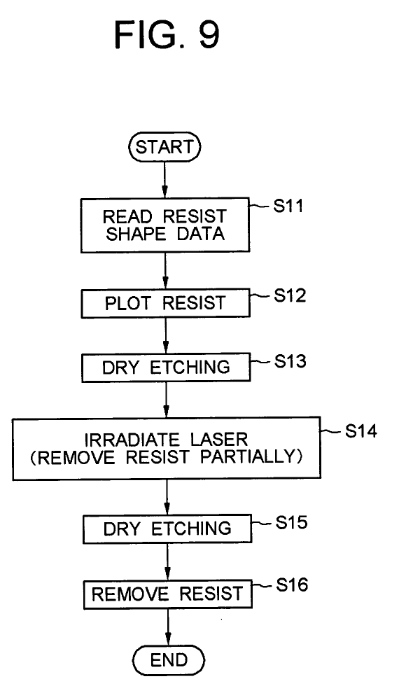

Next, a second embodiment of the present invention will be explained with reference to FIGS. 6 to 9. FIG. 6 is a block diagram showing the configuration of an apparatus for forming an air bearing surface of a magnetic head. FIGS. 7A to 8D are explanatory diagrams showing states of forming an air bearing surface of a magnetic head. FIG. 9 is a flowchart showing the operation of the apparatus for forming an air bearing surface.

[Configuration]

An apparatus for forming an air bearing surface of a magnetic head in the present embodiment includes, in addition to the configurations explained in the embodiment 1, laser irradiating devices 7 and 8 for irradiating a laser beam to a resist formed on the magnetic head 1. Therefore, in the computing device 41 of the controller 4, there is constructed a laser irradiating control processor (not shown) for controlling the operation of the laser irradiating devices 7 and 8.

More specifically, as shown in FIG. 6, the laser irradiating devices 7 and 8 consist of a laser torch 7 for irradiating a laser beam, and a laser drive 8 which supports the laser torch 7, controls the laser irradiating operation and controls movement of the laser torch 7 so as to set a laser irradiating position.

The laser torch 7 is, for example, one outputting a maxima laser which is irradiated to a resist having been applied (plotted) on the magnetic head 1 so as to heat a part of the resist and remove it. Therefore, a resist material to be applied to the magnetic head 1 is made of a material which is subject to thermal decomposition with a heat of the laser beam, such as a polymeric material including C, H and N. Specifically, styrene resin having EL (ethyl lactate) as a solvent, and styrene resin having PGMEA (propylene glycol monomethyl ethyl acetate) as a solvent can be used. Note that the resist may be removed by such an action that the resist is sublimated by being heated with a laser beam. In such a case, a material capable of being sublimated by a laser beam is used as a resist material, as described above. Further, processing of removing a part of the resist by using a laser beam is not limited to be performed by the action described above, and it may be removed by another principle using the irradiation energy of the laser beam. Further, the laser torch 7 is drive-controlled by the laser drive 8 supporting it, is movable in an X-Y direction at a speed of not less than 0.1 mm/sec, and has a positioning accuracy of less than 2 μm. Then, according to a control instruction from the controller 4, the laser drive 8 moves the laser torch 7 and controls irradiation of a laser beam so as to form a resist in a predetermined shape.

Further, the laser irradiation control processor (not shown) formed in the controller 4 outputting a control instruction to the laser drive 8 reads out resist shape data, which should be formed in the current process, from the resist shape data memory 46 as same as the inkjet control processor 42 described above, and transmits an instruction to the laser drive 8 so as to form the resist of such a shape on the air bearing surface of the magnetic head 1 mounted on the table 5. At this time, a control instruction relating to the positioning of the laser torch 7 is outputted such that a control is performed corresponding to the operation of the table 5 on which the magnetic head 1 is mounted which is the object of irradiating the laser beam. That is, it is controlled to enable an appropriate positioning in cooperation with the table control processor 43. Thereby, movement of the laser torch 7 can be controlled rapidly with high accuracy, whereby resist formation processing can be performed rapidly with high accuracy.

In the present embodiment, a resist shape formed by irradiating a laser beam is a shape which can be formed by removing a part of a resist shape plotted by using the inkjet device 2 as described above. More specifically, in the first cycle, a resist is plotted by the inkjet device 2 and etching is performed, and the resist is used as it is and a part thereof is removed by a laser, whereby a resist shape of the second cycle is formed. Further, although explanation will be only given for etching of the second cycle below, in a case where etching is further performed and if it is possible to form a resist shape usable in the following etching by removing a part of the resist having been formed, a resist formation by irradiating a laser beam may be repeated.

[Operation]

Next, the operation of a method of forming an air bearing surface (method of forming a surface shape) by using the apparatus for forming an air bearing surface of a magnetic head in the embodiment 2 will be explained below with reference to FIGS. 7A to 8D. FIGS. 7A to 8D show states of an air bearing surface by respective steps of forming an air bearing surface shape having irregularities on the air bearing surface of the magnetic head 1. In each Figure, a plan view of the air bearing surface of the magnetic head 1 in each stage is shown in the upper part, and a central sectional view thereof is shown in the lower part. Further, FIG. 9 is a flowchart showing the operation of the apparatus for forming an air bearing surface of a magnetic head at that time.

First, the inkjet control processor 42 and the table control processor 43 of the controller 4 read out resist shape data from the resist shape data memory 46 (step S11), and based on the data, move the inkjet device 2 and the table 5, and plot a resist in a predetermined shape by discharging the resist material A from the inkjet device 2 (step S12, resist forming step). For example, in the first cycle, a resist A1 of the shape shown by the shaded part in FIG. 7B is formed on the flat air bearing surface (denoted by the reference numeral 11) of the magnetic head 1 shown in FIG. 7A.

Next, to the air bearing surface of the magnetic head 1 on which the resist A1 is formed, dry etching is performed by an etching device (not shown) (step S13, etching step). With this step, as shown in FIG. 7C, a part where the resist A1 is not formed is eroded by a predetermined height, whereby a low level (dented part) denoted by the reference numeral 12 is formed. Thereby, the air bearing surface of the magnetic head 1 is formed to be in a stepped shape (dented shape) such that the part denoted by the reference numeral 11 is the highest and the part denoted by the reference numeral 12 is low. In this way, the first cycle ends. It is same as the embodiment 1 up to this point.

Next, resist formation of the second cycle in the present embodiment is performed by irradiating a laser by the laser torch 7 to the resist A1 having been formed as described above so as to remove the unnecessary part (laser irradiating step). More specifically, based on the resist shape of the second cycle included in the resist shape data read out from the resist shape data memory 46, the laser torch 7 and the table 5 are moved, and a laser beam is irradiated from the laser torch 7 so as to remove a part of the resist A1 to thereby from a predetermined shape. For example, by removing a part from the resist shape A1 shown in FIG. 7C, the resist A1 of the shape shown in FIG. 7D is formed. Note that a part indicated by the dotted line shown in the sectional view in FIG. 7D is a part where the resist is removed by the laser beam.

Then, dry etching is performed by an etching device (not shown) to the air bearing surface of the magnetic head 1 in a state where the resist A1 of the shape shown in FIG. 8A is formed (step S15, etching step). With this step, as shown in FIGS. 8B and 8C, a part where the resist A1 is not formed is eroded by a predetermined height. Note that a shape indicated by the dotted line in FIG. 8B shows a position of the air bearing surface before etching. Thereby, on the plane of the height denoted by the reference numeral 11 before etching, a low level denoted by the reference numeral 12 is formed, and on the plane of the height denoted by the reference numeral 12 before etching, a lower level denoted by the reference numeral 13 is formed, whereby the air bearing surface having two stages of level difference is formed. Note that the height shown by the reference numeral 12 formed in the second cycle and the height shown by the reference numeral 12 formed in the first cycle are not limited to be the same height. For example, they may differ depending on the etching time in each cycle or the like.

Then, the resist A1 formed on the magnetic head 1 is removed by a resist removing device (not shown) (step S16, resist removing step), and formation of the air bearing surface is completed as shown in FIG. 8D.

In this way, by irradiating a laser beam while performing the positioning thereof with high accuracy, it is possible to form a resist in a desired shape with high accuracy, whereby the shape of the air bearing surface of the magnetic head can be formed with high accuracy by etching. In particular, a new resist shape can be formed by removing a part of the resist having been plotted, whereby the resist can be utilized effectively, so it is possible to reduce the etching cost and to reduce the processing time.

Although a case of forming an air bearing surface shape in two stages by two-cycle etching has been exemplary described in the above, etching may be performed further for forming more level differences. In such a case, if it is possible to form a new resist by removing a part of the resist shape shown in FIG. 8C, a laser beam is irradiated to the resist in the same manner as described above to thereby form a new resist. In other words, following step S15 in FIG. 15, step S14 and step S15 may be performed once more or repeated for plural times.

Further, although a case where a new resist shape is formed by removing a part of the resist plotted on the magnetic head 1 by the inkjet device 2 has been exemplary described in the above, a new resist shape may be formed by irradiating a laser beam to a resist applied separately to the magnetic head 1 for example, and by removing a part of the resist. That is, after the first cycle which has been completed through dry etching in step S13 in FIG. 9, a resist shape of the next cycle may be formed in such a manner that all resist is removed, and then a new resist is applied by the inkjet device 2 or any other method to the magnetic head 1 separately, and a laser beam is irradiated to the resist (step S14).

### Embodiment 3

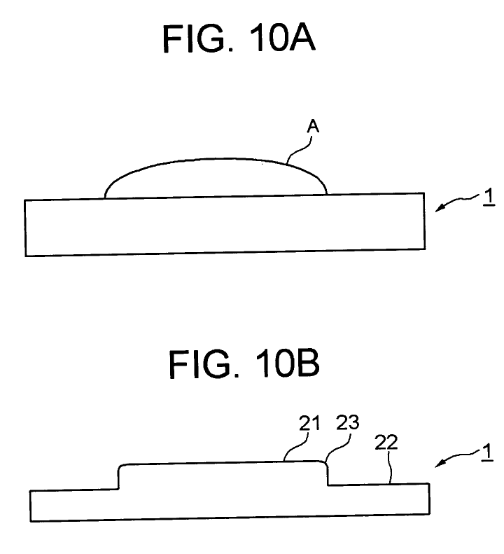

A third embodiment of the present invention will be explained with reference to FIGS. 10A and 10B. FIG. 10A is a diagram showing a state where a resist is formed on the magnetic head 1 which is the etching object, and FIG. 10B is a diagram showing a state after etching. Although an explanation will be given below for a case where an air bearing surface of the magnetic head is formed by using the method of forming an air bearing surface and the apparatus for forming an air bearing surface described above, the shape of the magnetic head described below may be formed by using any method and any apparatus.

First, as described above, the resist material A is discharged to the magnetic head 1 by an inkjet device so as to plot a resist in a predetermined shape. Then, as shown in FIG. 10A, the resist material A is applied in such a state that the circumference, that is, the corner of the resist A is rounded. Next, dry etching is performed by an etching device to the air bearing surface of the magnetic head 1 on which the resist A is formed. With this step, as shown in FIG. 10B, a part where the resist A has not been formed is eroded by a predetermined height, whereby a low level difference (dented part) indicated by the reference numeral 22 is formed. In other words, a protruded part indicated by the reference numeral 21 is formed on the air bearing surface. At this time, the circumference, that is, the corner of the protruded part 21 indicated by the reference numeral 23 is formed to be rounded with a predetermined radius. For example, a radius (R) of 2 to 5 nm (nanometer) is formed.

In this way, a fine radius is formed in the corner of the protruded part 21 on the air bearing surface. With the protruded part 21 being rounded, the flying characteristics of the magnetic head can be improved. In particular, it is preferable that the radius of the corner of the protruded part 21 be formed to be 2 to 5 nm, and more preferable flying characteristics may be achieved if it is 2 to 3 nm. Such a radius is automatically formed by using a resist discharged and attached by using inkjet or the like as described above. Therefore, it is possible to form the shape of the air bearing surface rapidly with high accuracy as explained in the above-described embodiments, and to form a magnetic head with excellent flying characteristics as described in the present embodiment. Further, by constituting a head gimbal assembly or a hard disk drive in which such a magnetic head is mounted, it is possible to improve the performance of the hard disk drive.

### INDUSTRIAL AVAILABILITY

An apparatus for forming a surface shape which is the present invention can be used in a case of forming an air bearing surface of a magnetic head for example, and has an industrial availability.

1. A method of forming a surface shape, comprising:
a resist forming step in which a resist of a predetermined shape is formed on a predetermined surface of an etching object; and
an etching step in which etching is performed to the predetermined surface of the etching object on which the resist is formed, wherein
in the resist forming step, the resist of the predetermined shape is formed by discharging a resist material to the predetermined surface of the etching object.

2. The method of forming the surface shape as claimed in claim 1, wherein in the resist forming step, the resist material is discharged by an inkjet system or a bubble jet system.

3. The method of forming the surface shape as claimed in claim 1, wherein in the resist forming step, the resist material is discharged in a discharge amount of not more than 2 pl (picoliter).

4. The method of forming the surface shape as claimed in claim 3, wherein in the resist forming step, the resist material is discharged in a discharge amount of not more than 0.5 pl (picoliter).

5. The method of forming the surface shape as claimed in claim 1, further comprising, after the etching step, a resist removing step in which all of the resist formed is removed, wherein
after the resist removing step, the resist forming step and the etching step are performed repeatedly.

6. The method of forming the surface shape as claimed in claim 5, further comprising:
after the etching step, a laser irradiating step in which a laser beam is irradiated to the resist material formed on the etching object in another resist forming step which has been performed so as to remove a part of the resist material, and performing a new resist formation of a predetermined shape; and
after the laser irradiating step, the etching step.

7. The method of forming the surface shape as claimed in claim 6, wherein in the laser irradiating step, the resist material is thermally decomposed and removed by the laser beam.

8. The method of forming the surface shape as claimed in claim 7, wherein in the laser irradiating step, the resist material is sublimated and removed by the laser beam.

9. A method of forming an air bearing surface of a magnetic head, wherein
the etching object is a magnetic head, and
the air bearing surface of the magnetic head is formed by using the method of forming the surface shape as claimed in claim 1.

10. An apparatus for forming a surface shape comprising:
a resist forming device for forming a resist of a predetermined shape on a predetermined surface of an etching object; and
an etching device for performing etching to the predetermined surface of the etching object on which the resist is formed, wherein
the resist forming device includes a resist discharging device for forming the resist of the predetermined shape by discharging a resist material on the predetermined surface of the etching object.

11. The apparatus for forming the surface shape as claimed in claim 10, wherein the resist discharging device discharges the resist material by an inkjet system or a bubble jet system.

12. The apparatus for forming the surface shape as claimed in claim 10, further comprising a resist removing device for removing all of the resist formed on the predetermined surface of the etching object.

13. The apparatus for forming the surface shape as claimed in claim 10, further comprising a control device for controlling an operation of the resist discharging device, wherein
the control device stores resist shape data indicating a shape of a resist to be formed on the predetermined surface of the etching object, and based on the resist shape data stored, the resist is formed.

14. The apparatus for forming the surface shape as claimed in claim 10, further comprising a laser irradiating device for irradiating a laser beam to the resist material formed on the etching object so as to remove a part of the resist material, and performing a new resist formation of a predetermined shape.

15. The apparatus for forming the surface shape as claimed in claim 14, further comprising, a control device for controlling an operation of the laser irradiating device, wherein
the control device stores resist shape data indicating a shape of a resist to be formed with respect to the predetermined surface of the etching object, and based on the resist shape data stored, controls the operation of the laser irradiating device so as to form the resist.

16. The apparatus for forming the surface shape as claimed in claim 10, further comprising a movable table, on which the etching object is mounted, moving along a mounting surface so as to set a position of the etching object when forming the resist by the resist discharging device.

17. The apparatus for forming the surface shape as claimed in claim 16, wherein the resist discharging device moves corresponding to a moving operation of the movable table, and discharges the resist material.

18. The apparatus for forming the surface shape as claimed in claim 16, wherein the movable table moves along the mounting surface so as to set the position of the etching object when forming the resist by the laser irradiating device provided in the apparatus for forming the surface shape, said apparatus further comprising a laser irradiating device for irradiating a laser beam to the resist material formed on the etching object so as to remove a part of the resist material, and performing a new resist formation of a predetermined shape.

19. The apparatus for forming the surface shape as claimed in claim 18, wherein the laser irradiating device moves corresponding to a moving operation of the movable table and irradiates the laser beam.

20. An apparatus for forming an air bearing surface of a magnetic head, wherein
the etching object is a magnetic head, and
the air bearing surface of the magnetic head is formed by using the apparatus for forming the surface shape according to claim 10.

21. A magnetic head in which a corner of a protruded part in a predetermined shape formed on an air bearing surface facing a magnetic disk has a predetermined radius.

22. The magnetic head as claimed in claim 21, wherein the radius is 2 to 5 nm (nanometer).

23. A magnetic head in which a corner of a protruded part in a predetermined shape, formed by using the method of forming the surface shape as claimed in claim 1 on an air bearing surface facing a magnetic disk, has a predetermined radius.

24. A head gimbal assembly comprising the magnetic head as claimed in claim 21.

25. A hard disk drive comprising the magnetic head as claimed in claim 21.
